(19) United States
(12) Patent Application Publication
(10) Pub. No.: US 2014/0359048 A1
(43) Pub. Date: Dec. 4, 2014

(54) Caching in a Telecommunication Network

(71) Applicants: Jari Vikberg, Jarna (SE); Lars Westberg, Enkoping (SE)

(72) Inventors: Jari Vikberg, Jarna (SE); Lars Westberg, Enkoping (SE)

(73) Assignee: Telefonaktiebolaget L M Ericsson (pulb), Stockholm (SE)

(21) Appl. No.: 14/345,564

(22) PCT Filed: Sep. 23, 2011
(86) PCT No.: PCT/SE2011/051141

§ 371 Date: Mar. 18, 2014

(51) Int. Cl. H04L 29/08

(52) U.S. Cl. CPC H04L 67/2842
USPC 709/213

(57) ABSTRACT

A net-work node (1) of a telecommunication network (6) controls a play-out of cached content to a user equipment (2a, 2b). The network node retrieves an address contained in a response from the core network (5) to a request associated with the user equipment. If the network node detects that the address is associated with a defined server, e.g. a credit refill server or an advertisement server, the play-out of cached content to the user equipment is disabled. The play-out is activated again when a response to an additional request contains an address that is associated with another source than said defined server.

### TECHNICAL FIELD

The disclosure relates to a method in a network node of a telecommunication network for controlling a play-out of cached content to a user equipment. The disclosure also relates to a network node arranged to control a play-out of cached content to a user equipment. The disclosure also relates to a caching unit, a radio base station, an eNodeB, a radio network controller, RNC, and a base station controller, BSC, comprising such a network node.

### BACKGROUND

The 3GPP LTE (3rd Generation Partnership Project Long Term Evolution) is a project for improving the UMTS (Universal Mobile Telecommunication System)-standard, in order to cope with future requirements in terms of improved services, such as higher data rates, improved efficiency, and lower costs. The radio access network of an LTE system is commonly referred to as an E-UTRAN (Evolved Universal Terrestrial Radio Access Network), and the UTRAN is the radio access network according to the UMTS.

In an E-UTRAN, a user equipment, UE, is connected to a radio base station commonly referred to as an eNodeB (evolved NodeB), which is connected to a node in a CN (Core Network).

In a UTRAN, a user equipment is connected to a radio base station commonly referred to as a NodeB, and the NodeB is connected to a network node of the UTRAN, typically an RNC (Radio Network Controller), which is connected to the CN (Core Network).

In a radio access network according to the 2^{nd} generation, such as a radio access network of the GSM (Global System for Mobile communication), the radio base station is referred to as a BTS (Base Transceiver Station), which is connected to a core network via a network node of the radio access network, typically a Base Station Controller (BSC).

Caching in a mobile (telecommunication) network involves that a copy of content, e.g. Internet media content, is stored in a cache server located within the telecommunications network, when the content is retrieved from e.g. a media server by an end-user. Thus, a copy of the content will be stored closer to the end-users, for example in the radio access network or in the core network, and will be available to other end-users. Thus, when another end-user (or the same end-user) is requesting the stored media content, it will be played-out directly from the cache server. Thereby, the request does not have to be forwarded to the core network, and the content does not have to be downloaded from the media server again. Since a large percentage of the Internet traffic is repetitive, the caching of e.g. Internet media content in the mobile network will reduce the sending of repeating content all the way from its origin to the end-user.

An advantage with caching in a mobile network is that it will decrease the transport cost, since a cached content in principle only has to be transferred once in the transmission links above the cache server. Another advantage is that it will improve the Quality of Experience for the end-user, due to a lower delay, since a content can be retrieved faster from a cache server located in the telecommunication network, than from an original location, e.g. a media server.

Thus, caching in a mobile network may be used e.g. for media distribution towards a mobile end-user, wherein the media can be played-out to the mobile end-user directly from the cache server in the telecommunications network, instead of retrieved as downloadable media from a media server or from another user.

FIG. 1 illustrates how media content from a media server 7 is pushed to a cache server 3 of a mobile network 6, wherein mobile end-users 2a, 2b, are able to retrieve the content directly from the cache server, instead of having to download it from the media server. The cache server 3 and the network node 1 for controlling the caching are typically located in the radio access network 4, but they could also be located in the core network 5. Obviously, other types of content than media content may also be cached.

Charging in a mobile network, e.g. online charging or off line charging, is performed by the different core networks and the service network nodes. In online charging, the charging information, e.g. regarding a subscriber credit, may affect a service to the end-user/subscriber in real time, and an Online Charging System, OCS, typically performs real time credit control of a subscriber/end-user.

FIG. 2 schematically illustrates the functions of online charging, and the CN Domain 21, the Service Element 22 and the Sub-system 23. The CTF 28 (Charging Trigger Function) generates charging events based on the observation of network resource usage. The CTF collects information pertaining to chargeable events and assembles this information into matching charging events. The CTF delays the actual resource usage until permission has been granted by the OCS 25 (Online Charging System), tracks the availability of resource usage permission during the network resource usage, and enforces a termination of the end user's network resource usage when permission by the OCS is not granted, or has expired, e.g. when the subscriber of the end user is out of credit. The OCS comprises an OCF 29 (Online Charging Function), an RF 27 (Rating Function) for determining the value of the network resource usage, and an ABMF 26 (Account Balance Management Function.

In on-line charging, the services provided to an end-user will be affected by the credit control performed by the OCS. However, if a copy of a media content requested by the end-user has been previously stored in a cache server, this cached content may be played-out to a user equipment of the end-user, even though the subscription has run out of credit.

Further, an end-user may be redirected to an advertisement server in order to receive an advertisement inserted e.g. in a media stream. However, if the media content has been previously stored in a cache server, this content may be played-out to the end-user anyway.

Thus, it is an overall problem that a cached content, e.g. media content, is always played-out to the end-user.

### SUMMARY

It is an object of exemplary embodiments described hereinafter to address at least some of the issues outlined above, and this object and others are achieved by the methods and the arrangements according to the appended independent claims, and by the embodiments according to the dependent claims.

A first aspect of the exemplary embodiments provides a method in a network node of a telecommunications network for controlling a play-out of cached content to a user equipment. The method comprises the network node retrieving an address contained in a response to a request, wherein the request is associated with the user equipment, and disabling a play-out of cached content destined to the user equipment, when detecting that the retrieved address is associated with a server belonging to a defined set of one or more servers. Said defined set of servers may be a set of credit refill servers or advertisements servers.

The request may be sent from the user equipment, or, alternatively, being initiated and sent by the network node.

The network node may further retrieve an additional address, which is contained in a response to an additional request that is associated with the user equipment, and activate a disabled play-out of cached content to the user equipment, when detecting that the retrieved additional address is associated with another source than said server belonging to the defined set of servers.

The detecting may comprise the network node comparing any of the one or more retrieved addresses with a stored listing of addresses associated with the defined set of servers, and the response containing the retrieved address may be a Domain Name System-reply, or alternatively, the retrieved address may be a source address, e.g. an IP address.

The network code may further update a listing of user equipment to which a play-out of cached content is disabled.

A second aspect of exemplary embodiments provides a network node connectable to a telecommunications network, wherein the network node is arranged to control a play-out of cached content to a user equipment. The network node comprises a receiver configured to receive a response to a request, wherein the request is associated with the user equipment. The network node also comprises a processing circuitry configured to retrieve an address contained in the response, and disable a play-out of cached content destined to the user equipment, when detecting that the retrieved address is associated with a server belonging to a defined set of one or more servers.

The processing circuitry may be further configured to retrieve an additional address contained in a response to an additional request that is associated with the user equipment, and to activate a disabled play-out of cached content to the user equipment, when detecting that the retrieved additional address is associated with another source than said server belonging to the defined set of servers.

The network node may further comprise a memory for storing a listing of addresses associated with servers belonging to a defined set of servers.

The network node may comprise a memory for storing a listing of identities to user equipments to which a play-out of cached content is disabled, wherein the processing circuitry is configured to update the listing.

A third aspect of exemplary embodiments provides a caching unit comprising a cache server connected to a network node according to exemplary embodiments.

A fourth aspect of exemplary embodiments provides a radio base station, e.g. an eNodeB, connectable to a radio access network, wherein the radio base station comprises a network node according to exemplary embodiments.

A fifth aspect of exemplary embodiments provides an RNC that is connectable to a UTRAN, or a BSC that is connectable to a GSM radio access network, wherein the RNC or the BSC comprises a network node according to exemplary embodiments.

It is an advantage with exemplary embodiments that a network node, e.g. in a radio access network, can disable a play-out of cached content to an end-user in an uncomplicated way, e.g. when a subscription is out of credit, or when the end-user is redirected to an advertisement server. Another advantage is that the play-out can be easily activated again, e.g. when the subscription has been paid, or when the advertisement has been received by the end-user.

### BRIEF DESCRIPTION OF THE DRAWINGS

Exemplary embodiments will now be described in more detail, and with reference to the accompanying drawings, in which:

FIG. 1 schematically illustrates exemplary caching of Internet media content from a media server;

FIG. 2 schematically illustrates exemplary functions of online charging in a 3GPP mobile network;

FIG. 3 schematically shows an exemplary caching architecture comprising a radio access network, RAN, a core network, CN, and a media server, in order to illustrate a redirection of a request;

The FIGS. 4a, 4b and 4c are flow diagrams illustrating methods in a network node of disabling the play-out of cached content to a user equipment belonging to an end-user, according to exemplary embodiments;

FIG. 5 is a flow diagram of a method in a network node of activating a disabled play-out of cached content, according to exemplary embodiments;

FIGS. 6a and 6b schematically illustrates an exemplary network node, and its processing circuitry;

FIG. 7 schematically illustrates an exemplary caching unit, comprising a network node and cache server;

FIG. 8a schematically illustrates a radio base station comprising an exemplary network node and a cache server, and FIG. 8b schematically illustrates an RNC or a BSC comprising an exemplary network node and a cache server.

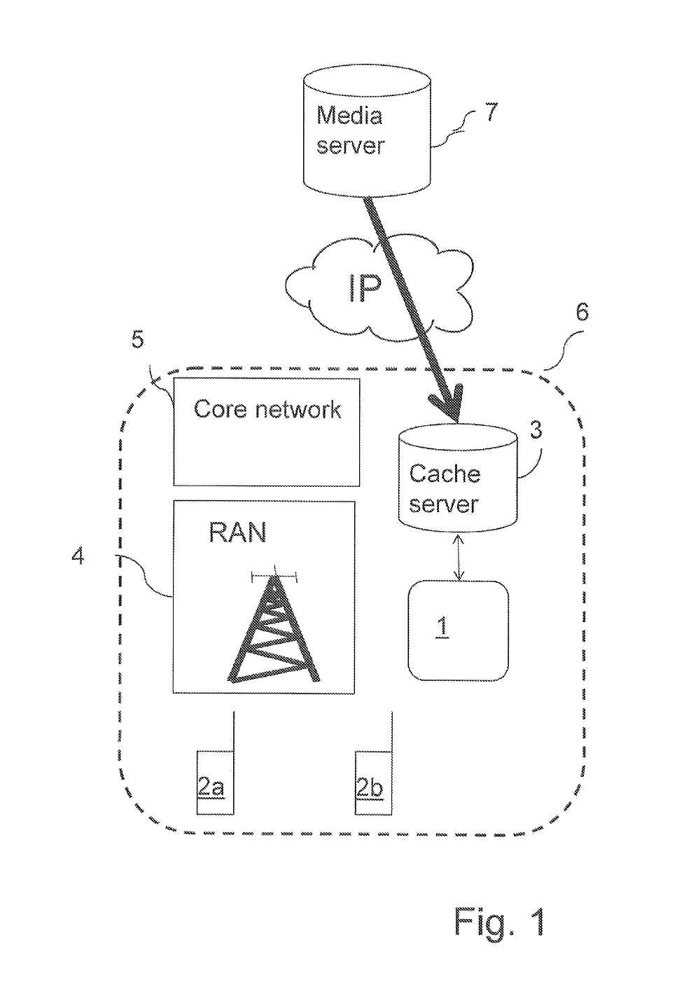

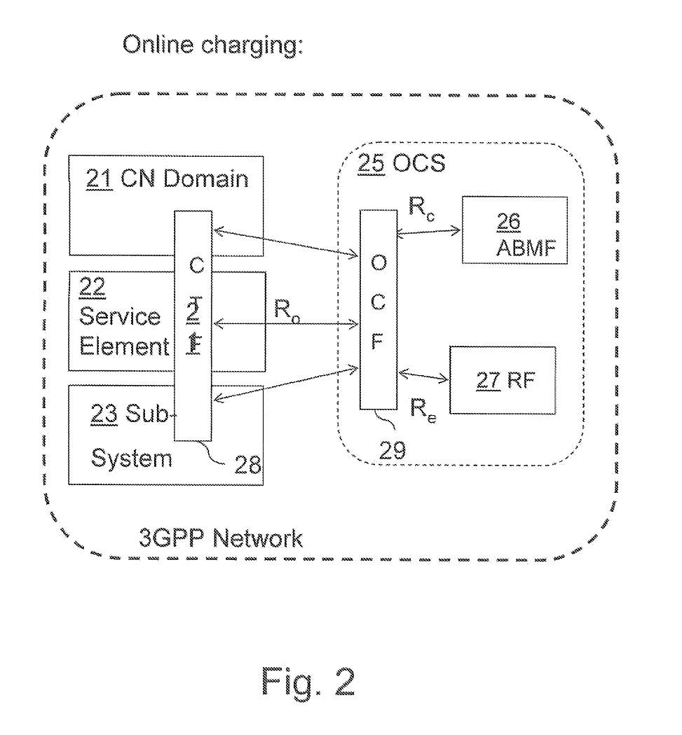

### DETAILED DESCRIPTION

In the following description, different exemplary embodiments are described in more detail, with reference to accompanying drawings. For the purpose of explanation and not limitation, specific details are set forth, such as particular scenarios and techniques in order to provide a thorough understanding.

Moreover, it is apparent that the functions and means explained below may be implemented using software functioning in conjunction with a programmed microprocessor or general purpose computer, and/or using an application specific integrated circuit (ASIC). Further, while the embodiments are primarily described in the form of methods and devices, the embodiments may also be implemented as a computer program product or in a system comprising a computer processor and a memory coupled to the processor, wherein the memory is encoded with one or more programs that may perform the functions disclosed herein.

Furthermore, particular aspects of the embodiments are described in a non-limiting general context in relation to an E-UTRAN, a UTRAN or a GSM RAN. However, it should be noted that the embodiments may also be applied to other types of radio access networks. The user equipments described herein may include e.g. mobile telephones, pagers, headsets, laptop computers and other mobile terminals.

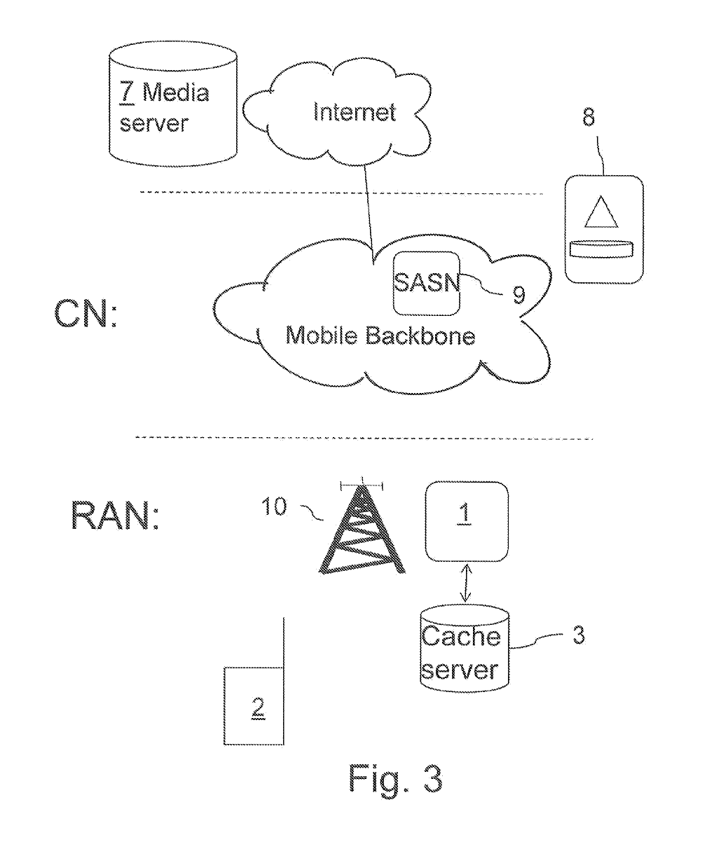

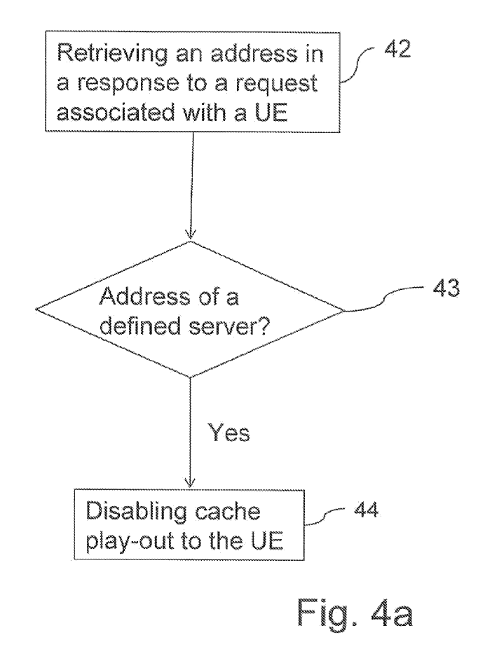

FIG. 3 schematically illustrates an exemplary caching-architecture, wherein copies of content retrieved from a media server 7 can be stored in a cache server 3 located in the radio access network, RAN. A network node 1 controls the caching, i.e. the storing of content in the cache server and the play-out of the cached content from the cache server to a user equipment, UE, 2. As described above, during online charging of a service provided to an end-user/subscriber associated with a UE, the subscriber may run out of credit. In such a case, a node in the core network, e.g. an SASN 9 (Service Aware Support Node), may redirect a content request to a credit refill server 8, instead of providing the content from the media server 7. This redirection is preceded by the CN detecting that a pre-paid subscription of the end-user has run out of credit. Thus, when the end-user of the UE 2 attempts to access an Internet home page from the media server 7, e.g. a home page belonging to a newspaper, and no copy of the home page has been previously stored in the cache server 3, the mobile CN will receive a UE HTTP request from the UE to access the home page of the newspaper. However, if the subscription has run out of credit, the request is redirected to a so-called refill home page at the credit refill server 8 instead. This refill home page may be the only home page the end user is allowed to access until he/she has paid his/her subscription.

The above-described situation, that a requested content is not found in a cache server, and the request is forwarded to the core network, is commonly referred to as a cache miss. The opposite situation, i.e. that a requested content is found in a cache server, is commonly referred to as a cache hit.

Conventionally, if an Internet home page requested by the UE has been previously stored in the cache server 3, (i.e. a cache hit), the UE will be able to retrieve the home page from the cache server, even though the subscription associated with the UE has run out of credit.

However, according to an embodiment disclosed herein, the network node 1 controlling the cache server 3 will disable the play-out of cached content to this end user when his/her subscription has run out of credit, and activate the play-out when the subscription is paid. This is accomplished by the network node inspecting downlink traffic to the UE and discovering when a subscription associated with a UE is out of credit, e.g. by detecting that an address retrieved in a response to a request associated with the UE is associated with a credit refill server. When the network node has discovered that a UE is out of credit, it disables a play-out of cached content to this UE. In order to activate the play-out again when the subscription is paid, the network node may continue to inspect downlink traffic to the UE, in order to discover when the UE is not out of credit anymore.

According to an exemplary embodiment, the network node discovers that a subscription is out of credit by performing packet inspection of downlink traffic to a UE, and determining if an address contained in a response from the core network to a request from the UE is associated with a specific server, e.g. with a credit refill server. If an address associated with such a server is detected, this indicates that the request will be, or has been, redirected to this specific server by the CN. In a first alternative embodiment, the network node inspects the response to a DNS query from a TE, and in a second alternative embodiment, the network node inspects the source address, e.g. an IP address, of a response to a content request. In said first alternative embodiment, an answer to a DNS query from the UE for a host name, e.g. www.cnn.com, has been overwritten by the core network, and an address, e.g. an IP address, to a defined server, e.g. a credit refill server, has been returned to the UE in a DNS reply. Upon receiving the address, the UE will establish a connection with the defined credit refill server instead of with the CNN-server. In the second alternative embodiment, the IP layer has redirected a content request from the UE to the defined server, e.g. a credit refill server, and the response contains the address of this server as a source address.

Another exemplary embodiment is related to control of a play-out of cached content, when an advertisement is inserted in a media stream. In such a case, an end-user may be charged with a lower price, e.g. for accessing an Internet media content, since the operator is able to get a revenue from the advertisement. According to this exemplary embodiment, a play-out of cached media content to an end-user should be disabled temporarily, when the end-user has been redirected to an advertisement server, and the play-out of cached content should be activated again when the end-user receives traffic from a different server than the advertisement server. Thus, in this embodiment, the play-out of cached content to the UE is disabled when the network node detects that an address retrieved in a response from the core network to a request from a UE, or on behalf of a UE, is associated with a server belonging to a defined set of advertisement servers. Further, the play-out may be activated again when the network node detects an address associated with a different server than said advertisement server in a response to a request.

According to an exemplary embodiment, the network node 1 will retrieve an address, e.g. an IP address, contained in a response to a request, and compare with a listing of stored addresses to different servers belonging to a defined set of one or more servers, e.g. credit refill servers or advertisement servers, to which the core network may redirect the UE, e.g. when a subscription is out of credit, or for providing an advertisement to the end-user. If the network node is able to find the retrieved address in the listing of stored addresses, it will disable the play-out of cached content to the UE. According to a further embodiment, the network node will also store an identity of the UE, e.g. in a listing of IMSIs (International Mobile Subscription Identities) associated with the UEs to which a play-out of cached content is disabled.

According to a further exemplary embodiment, in order to activate the disabled play-out of cached content again, e.g. when the subscription has been paid or when the advertisement has been received by the end-user, the network node will retrieve an additional address contained in a response from the core network to an additional request from said UE, and activate a disabled play-out of cached content to the UE, when the retrieved address is associated with another source than a defined server. When the play-out is activated, the network node may also remove the UE from the listing of UEs.

The network node may investigate a response to a request initiated and sent to the core network by the UE, e.g. at a cache miss, but the network node may also initiate so-called test traffic, e.g. at certain defined events, and initiate and send a request to the core network itself, on behalf of a UE, and investigate the response. Such a test traffic request could e.g. be initiated and sent by the network node at a defined time interval after the last forwarding of a request to the core network.

Thus, according to a first exemplary embodiment, the network node investigates traffic created by the UE by retrieving an address contained in a response from the core network to a request initiated and sent by the UE. The retrieved address is inspected, and if an address associated with a server belonging to a defined set of servers is detected, the play-out of cached content is disabled by the network node. When a play-out of cached content to a UE is active, the network node may investigate traffic created by the UE e.g. when a cache miss takes place, i.e. that a content requested by the UE is not found in the cache server, and the request is forwarded to the core network.

According to a second exemplary embodiment, the network node sends test traffic associated with a UE, by initiating and sending a request to the core network on behalf of the UE, and retrieving an address contained in a response to the request. This test traffic may be initiated at certain events or with certain time intervals, e.g. when a defined time period has passed since a content request was forwarded to the core network.

Another exemplary embodiment combines the above-described first and second exemplary embodiments, and comprises the network node retrieving an address in a response to a request sent from the UE and forwarded to the core network, e.g. at a cache miss, the network node also sending test traffic at defined events, by retrieving an address in a response to a request initiated and sent to the core network by the network node itself, the request being associated with the UE.

The embodiment without test traffic, comprising the network node only inspecting a response to a request initiated by the UE, e.g. at a cache miss, is simple and requires no extra signalling. However, to inspect test traffic initiated by the network node will enable a faster detection, e.g. of an out of credit-situation.

Another embodiment disclosed herein is specifically directed to activating a play-out of cached content to a user equipment. However, the activating according to this embodiment could be preceded by a disabled play-out according to an embodiment disclosed herein. According to the embodiment specifically directed to activating a play-out of cached content to a user equipment, a network node 1 retrieves an address contained in a response to a request associated with the user equipment, and the address may be contained in DNS reply, or be a source address of the response. If the network node detects that the retrieved address is associated with another source than a specific server that belongs to a defined set of servers, the network node will activate a play-out of cached content to this user equipment. The detecting may be performed by the network node comparing the retrieved address with a stored listing of address associated with a defined set of servers, e.g. advertisement servers or credit refill servers.

FIG. 4a is a flow diagram schematically illustrating a method in a network node of a telecommunications network of controlling the play-out of cached content to a user equipment, according to an exemplary embodiment. In step 42, the network node retrieves an address in a response to a request associated with a user equipment, wherein the address may be contained in a DNS-reply, or may be a source address of the response. If detecting, in step 43, that the retrieved address, e.g. an IP address, is associated with a server belonging to a defined set of servers, e.g. a credit refill server or an advertisement server, the network node disables the play-out of the cached content to the user equipment, in step 44. The detecting, in step 43, may comprise comparing the retrieved address with a stored listing of addresses.

FIG. 4b is a flow diagram illustrating a first alternative embodiment of the method illustrated in FIG. 4a, according to which the network node retrieves an address in a response to a request sent from the user equipment, in step 42a, e.g. at a cache miss, and the following steps in FIG. 4b, i.e. step 43 and step 44, correspond to the steps 43 and 44 illustrated in FIG. 4a.

FIG. 4c is a flow diagram illustrating a second alternative embodiment of the method illustrated in FIG. 4a, according to which the network node retrieves an address in a response to a request associated with a user equipment, in FIG. 42b, the request being initiated and sent by the network node. This step is preceded by the network node initiating and sending this request on behalf of the user equipment, in step 41, e.g. at a defined event. The following steps in FIG. 4c, i.e. step 43 and step 44, correspond to the steps 43 and 44 illustrated in FIGS. 4a and 4b.

According to a further embodiment, the network node will update a listing of user equipment-identities to which a cache play-out is disabled, after disabling a cache play-out to a user equipment.

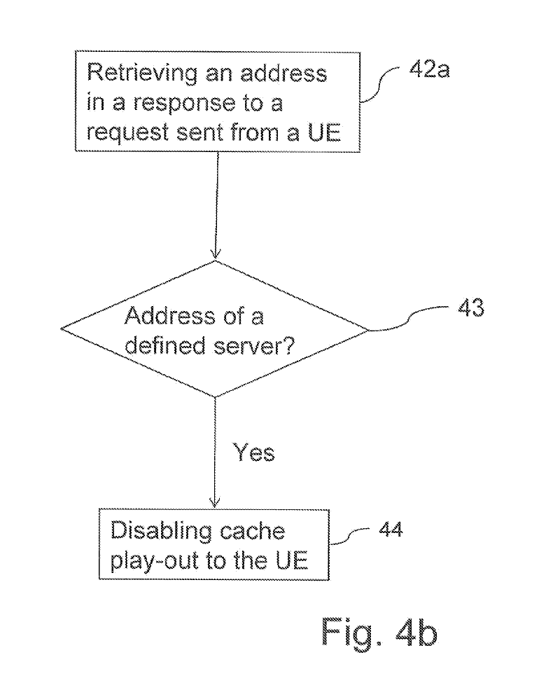

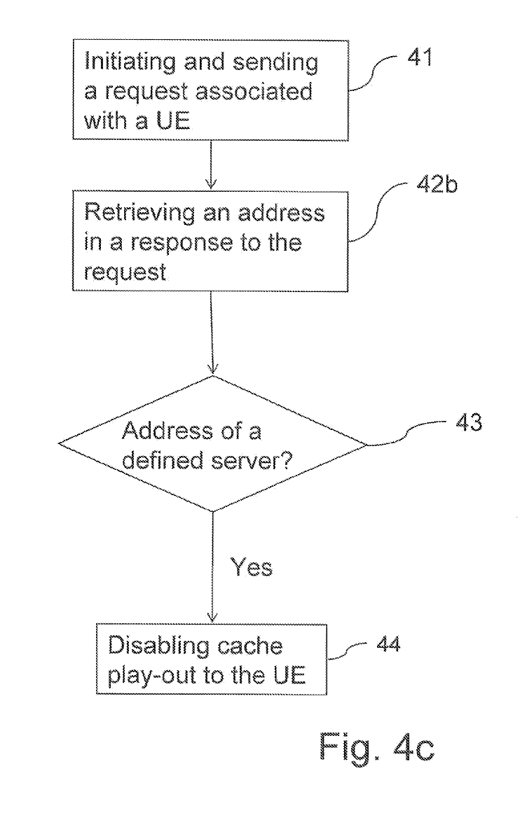

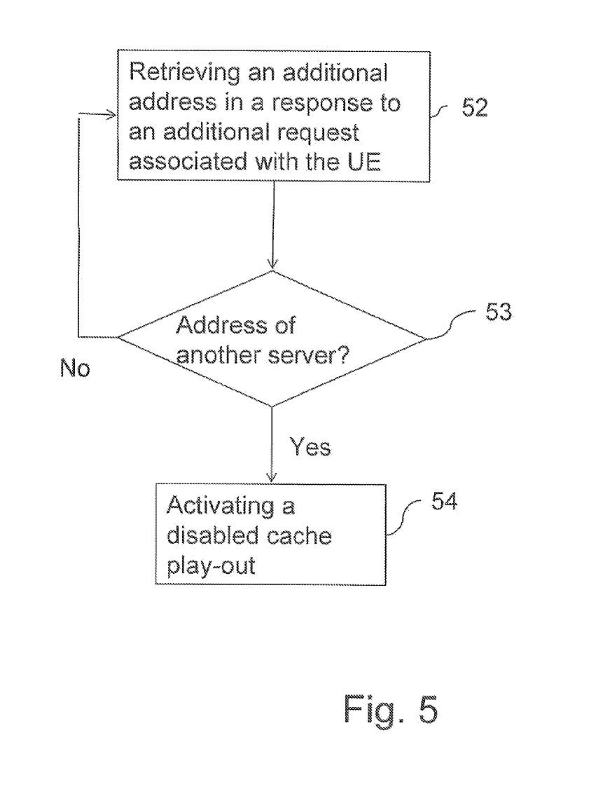

FIG. 5 is a flow diagram illustrating a method in a network node of a telecommunication network of activating a disabled play-out of cached content to a user equipment, according to an exemplary embodiment. In step 52, the network node retrieves an address in a response to an additional request associated with a user equipment, wherein the address may be contained in a DNS-reply, or may be a source address of the response. If detecting, in step 53, that the retrieved address is associated with another source than a server belonging to a defined set of servers, e.g. a credit refill server or an advertisement server, the network node activates a disabled play-out of the cached content to the user equipment, in step 54. However, if the retrieved address is an address of a server that belongs to the defined set of servers, then the play-out should not yet be activated. Instead, the network node will retrieve, in step 52, an additional address in a response to an additional request associated with the user equipment, and perform an additional detecting step, 53, followed by a step 54 or a repeated step 52, depending on the outcome of the detecting step. The detecting in step 53 may comprise comparing the retrieved address with a stored listing of addresses, e.g. IP-addresses.

According to a further embodiment, the network node will update a listing of user equipment-identities to which a cache play-out is disabled, by removing the identity of the user equipment to the listing, after activating a disabled cache play-out to the user equipment.

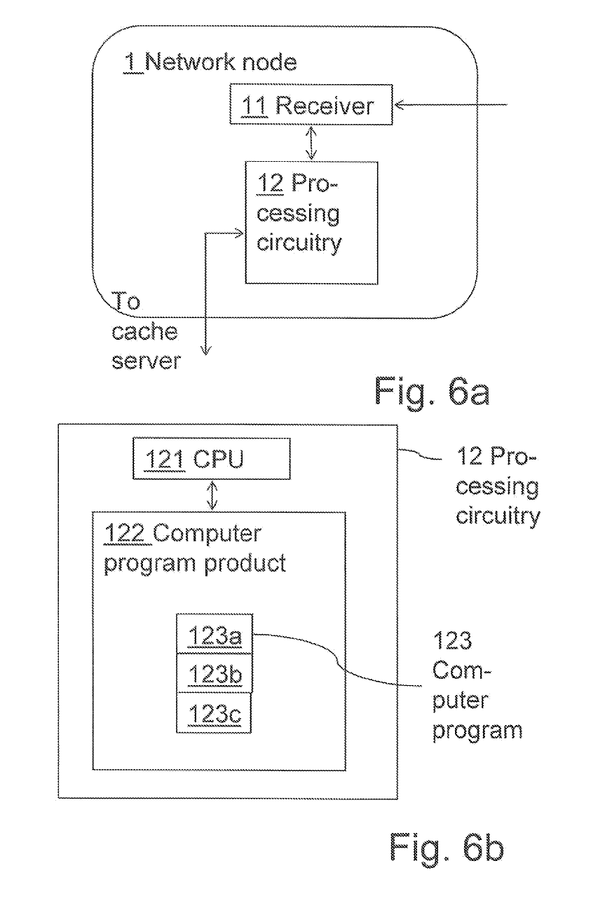

FIG. 6a illustrates schematically an exemplary network node 1, according to exemplary embodiments, the network node being connectable to a telecommunications network, e.g. to a radio access network or a core network, and arranged to control a play-out of cached content to a user equipment. The network node is further connectable to a cache server (not illustrated in the figure.) The network node is provided with suitable communication circuitry, comprising a receiver 11, which is configured to receive a response to a request associated with a user equipment. The network node is further provided with appropriate processing circuitry 12 connected to the receiver 11, the processing circuitry being configured to retrieve an address contained in the response, and disable a play-out of cached content to the user equipment, when detecting that the address is associated with a server belonging to a defined set of servers, e.g. of advertisement servers or credit refill servers.

The address, e.g. an IP address, may be retrieved from a response that is a DNS reply, or it may be the source address of the response.

Said request may be initiated and sent to the core network from the user equipment, e.g. at a cache miss, or may be initiated and sent to the core network by the network node itself on behalf of the user equipment, e.g. at a defined event.

According to an exemplary embodiment, the network node is further arranged to activate a disabled play-out of cached content to a user equipment. In this embodiment, the processing circuitry is configured to retrieve an additional address contained in a response to an additional request associated with the user equipment, e.g. sent from the user equipment, or initiated and sent by the network node on behalf of the user equipment. The processing circuitry is configured to activate a disabled play-out of cached content to the user equipment, when detecting that the retrieved address is associated with another source than a server belonging to a defined set of servers, e.g. by comparing the retrieved address, typically an IP address, with a stored listing of addresses to the servers. The addresses may be stored in a memory located in the network node (not illustrated in FIG. 6a).

According to a further embodiment, the processing circuitry is also configured to update a listing of identities of user equipments to which a play-out of cached content is disabled. Thus, when the processing circuitry of the network node disables a cache play-out to a certain user equipment, the processing circuitry will also add the identity of this user equipment to said listing. Similarly, when the processing circuitry activates a cache play-out to the user equipment, it will remove the identity of this user equipment from the listing. The listing is may be stored in a memory that is located in the network node (not illustrated in FIG. 6a).

FIG. 6b schematically illustrates the processing circuitry 12, as illustrated in FIG. 6a. The processing circuitry comprises a CPU 121, which may be a single unit or a plurality of units. Furthermore, the processing circuitry comprises at least one computer program product 122, in the form of a non-volatile memory, e.g. an EEPROM (Electrically Erasable Programmable Read-Only Memory), a flash memory or a disk drive. The computer program product 122 comprises a computer program 123 comprising computer program modules 123a,b,c, which when run on the network node 1 causes the CPU 121 to perform the steps performed in conjunction with FIG. 4a.

Hence, in the exemplary embodiment illustrated in FIG. 6b, the code means in the computer program 123 comprises a retrieving module 123a, a detecting module 123b, and a disabling module 123c, and the modules 123a, 123b and 123c may essentially perform the steps of the flow in FIG. 4a. However, one or more of the modules of the code means may in alternative embodiments be implemented partly as hardware circuits.

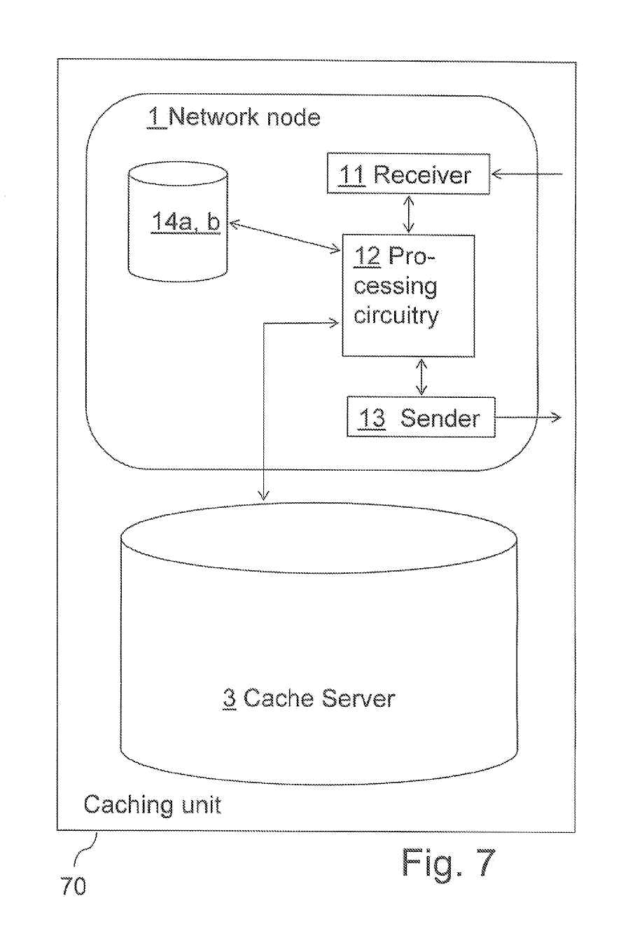

The network node 1 and the cache server 3 may be co-located to form a caching unit 70, or may alternatively be two separate devices that are connected to each other in order to perform the caching. FIG. 7 illustrates schematically an exemplary caching unit 70, comprising an exemplary network node 1 connected to a cache server 3, the network node comprising a receiver 11 and a processing circuitry 12. The illustrated network node further comprises a sender 13 for sending a request on behalf of a user equipment, a memory 14a for storing a listing of servers belonging to a defined set of servers, e.g. of advertisements servers or credit refill servers, and a memory 14b for storing a listing of identities of the user equipment to which a play-out of cached content is disabled. The memories 14a or 14b may be located in the same storage device, or in separate storage devices, even though only one storage device is illustrated in FIG. 7.

It should be noted that both the above-described network node 1 and the caching unit 70 may be implemented by physical or logical entities using software functioning in conjunction with a programmed microprocessor or general purpose computer, and/or using an application specific integrated circuit (ASIC). It may further include suitable internal and external storage devices, a processor or multiple processor cores, as well as appropriate communication interfaces, including hardware and software capable of performing the necessary modulating, coding, filtering and the like, as well as demodulating and decoding of signals.

The network node 1, or a caching unit 70, may be located e.g. in a radio base station for a radio access network, e.g. in an eNodeB for the E-UTRAN, or in a radio access network-node connected to the radio base station, e.g. in a radio network controller, RNC, for an UTRAN, or in a base station controller, BSC for a GSM RAN. However, since packet-switched traffic is normally encrypted in the GSM between the UE and a Serving GPRS (General Packet Radio Services) Support Node of the core network, an inspection of downlink traffic to a UE in a GSM RAN has to be adapted accordingly.

The network node, or a caching unit 70, may alternatively be located in a core network, CN, typically “below” the redirecting node, e.g. a SASN 9, as illustrated in FIG. 3.

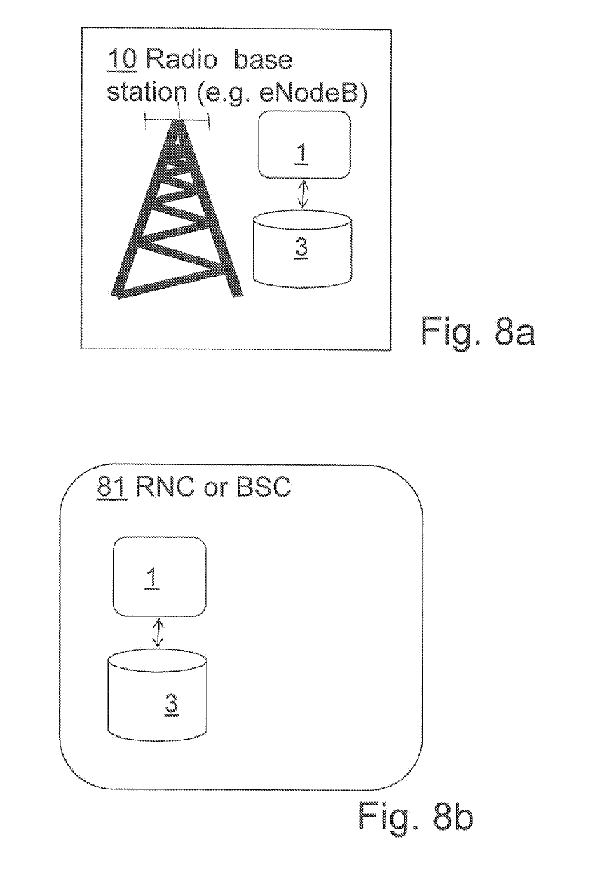

FIG. 8a illustrates a radio base station 10, e.g. an eNodeB for an E-UTRAN, wherein the radio base station comprises a network node 1 connected to a cache server 3. The network node illustrated in this figure corresponds to the network node which is illustrated e.g. in FIGS. 6a and 6b, and which is further discussed above. The radio base station 10 may alternatively be provided with a caching unit 70, as illustrated in FIG. 7, and comprising a network node 1 as illustrated in FIGS. 6a and 6b, and a cache server 3 connected to the network node 1.

FIG. 8b illustrates a radio access network-node 81, e.g. an RNC for a UTRAN or a BSC for a GSM RAN, provided with a network node 1 connected to a cache server 3. Similarly as in FIG. 8a, the network node 1 corresponds to a network node as illustrated e.g. in FIGS. 6a and 6b. Also, the radio access network-node 81 may alternatively be provided with a caching unit 70, as illustrated in FIG. 7, and comprising a network node 1 as illustrated in FIGS. 6a and 6b, and a cache server 3 connected to the network node 1.

It may be further noted that the above described embodiments are only given as examples and should not be limiting to the present invention, since other solutions, uses, objectives, and functions are apparent within the scope of the invention as claimed in the accompanying patent claims.

1-24. (canceled)

25. A method in a network node of a telecommunications network for controlling a play-out of cached content to a user equipment, the method comprising:
retrieving an address contained in a response to a request, wherein the request is associated with the user equipment; and
disabling a play-out of cached content destined to the user equipment, in response to detecting that the retrieved address is associated with a server belonging to a defined set of one or more servers.

26. The method of claim 25, wherein the request is sent from the user equipment.

27. The method of claim 25, wherein the request is initiated and sent by the network node.

28. The method of claim 25, further comprising:
retrieving an additional address, the address contained in a response to an additional request, wherein the additional request is associated with the user equipment;
activating a disabled play-out of cached content to the user equipment, in response to detecting that the retrieved additional address is associated with another source than said server belonging to the defined set of servers.

29. The method of claim 25, wherein the detecting comprises comparing any of the one or more retrieved addresses with a stored listing of addresses associated with the defined set of servers.

30. The method of claim 25, wherein the response is a Domain Name System reply.

31. The method of claim 25, wherein the retrieved address is a source address.

32. The method of claim 25, further comprising updating a listing of user equipment to which a play-out of cached content is disabled.

33. The method of claim 25, wherein said defined set of servers is a set of credit refill servers.

34. The method of claim 25, wherein said defined set of servers is a set of advertisements servers.

35. A network node connectable to a telecommunications network, the network node arranged to control a play-out of cached content to a user equipment, the network node comprising:
a receiver configured to receive a response to a request, wherein the request is associated with the user equipment; and
a processing circuitry configured to:
retrieve an address contained in the response, and
disable a play-out of cached content destined to the user equipment, when detecting that the retrieved address is associated with a server belonging to a defined set of one or more servers.

36. The network node of claim 35, wherein the request is sent from the user equipment.

37. The network node of claim 35, wherein the request is initiated and sent by the network node.

38. The network node of claim 35, wherein the processing circuitry is further configured to:
retrieve an additional address, the address contained in a response to an additional request, wherein the additional request is associated with the user equipment; and
activate a disabled play-out of cached content to the user equipment, in response to detecting that the retrieved additional address is associated with another source than said server belonging to the defined set of servers.

39. The network node of claim 35, comprising a memory for storing a listing of addresses associated with servers belonging to a defined set of servers.

40. The network node of claim 39, wherein the detecting comprises comparing any of the one or more retrieved addresses with the listing of addresses.

41. The network node of claim 40, wherein the processing circuitry is configured to compare an address retrieved from a Domain Name System reply with the stored listing of addresses.

42. The network node of claim 40, wherein the processing circuitry is configured to compare a retrieved source address of a response with the stored listing of addresses.

43. The network node of claim 35, comprising a memory configured to store a listing of identities to user equipments to which a play-out of cached content is disabled, wherein the processing circuitry is configured to update the listing.

44. A caching unit comprising a cache server connected to the network node of claim 35.

45. A radio base station connectable to a radio access network, the radio base station comprising the network node of claim 35.

46. An eNodeB connectable to an E-UTRAN, the eNodeB comprising the network node of claim 35.

47. A radio network controller (RNC) connectable to a UTRAN, the RNC comprising the network node of claim 35.

48. A base station controller (BSC) connectable to a GSM radio access network, the BSC comprising the network node of claim 35.
